(19) United States
(12) Patent Application Publication
(10) Pub. No.: US 2025/0287430 A1
(43) Pub. Date: Sep. 11, 2025

(54) METHODS FOR BEAM SPECIFIC POWER CONTROL

(71) Applicant: Nokia Technologies Oy, Espoo (FI)

(72) Inventors: Claudio ROSA, Aalborg (DK); Klaus Ingemann PEDERSEN, Aalborg (DK); Guillermo POCOVI, Aalborg (DK); Roberto MALDONADO, Aalborg (DK); Nuno Manuel KIILERICH PRATAS, Aalborg (DK)

(21) Appl. No.: 18/862,709

(22) PCT Filed: Apr. 25, 2023
(86) PCT No.: PCT/EP2023/060706

§ 371 Date: Nov. 4, 2024

Related U.S. Application Data
(60) Provisional application No. 63/338,852, filed on May 5, 2022.

(51) Int. Cl. H04W 74/0833; H04W 52/24

(52) U.S. Cl. CPC H04W 74/0833; H04W 52/242

(57) ABSTRACT

Systems, methods, apparatuses, and computer program products for power controls to allow UE to receive with similar SINR when transmitting during CLI slots and with Rx beam-specific cross link interference levels at a victim base station. One method may include receiving, by a UE, a set of SSB-specific PRACH target receive power values associated with a set of slots or symbols, and determining, by the UE, whether the set of slots or symbols comprises a RO.

### CROSS REFERENCE TO RELATED APPLICATION

This application claims the benefit of U.S. provisional application No. 63/338,852 filed on May 5, 2022, which is incorporated herein by reference in its entirety.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G) RAT, and/or other communications systems. For example, certain example embodiments may relate to systems and/or methods for beam-specific power controls to allow user equipment (UE) to receive with similar signal to interference plus noise ratio (SINR) when transmitting during cross link interference (CLI) slots and with receiver (Rx) beam-specific CLI levels at a victim base station.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a UE (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include calculating, by a network entity, at least one synchronization signal block-specific physical random access channel target receive power value. The method may further include signalling, by the network entity, the at least one synchronization signal block-specific physical random access channel target receive power value associated with a set of slots or symbols to a user equipment.

In accordance with certain example embodiments, an apparatus may include means for calculating at least one synchronization signal block-specific physical random access channel target receive power value. The apparatus may further include means for signalling the at least one synchronization signal block-specific physical random access channel target receive power value associated with a set of slots or symbols to a user equipment.

In accordance with various example embodiments, a non-transitory computer readable medium may be encoded with instructions that may, when executed in hardware, perform a method. The method may include calculating at least one synchronization signal block-specific physical random access channel target receive power value. The method may further include signalling the at least one synchronization signal block-specific physical random access channel target receive power value associated with a set of slots or symbols to a user equipment.

In accordance with some example embodiments, a computer program product may perform a method. The method may include calculating at least one synchronization signal block-specific physical random access channel target receive power value. The method may further include signalling the at least one synchronization signal block-specific physical random access channel target receive power value associated with a set of slots or symbols to a user equipment.

In accordance with certain example embodiments, an apparatus may include at least one processor and at least one memory including computer program code. The at least one memory and the computer program code may be configured to, with the at least one processor, cause the apparatus to at least calculate at least one synchronization signal block-specific physical random access channel target receive power value. The at least one memory and the computer program code may be further configured to, with the at least one processor, cause the apparatus to at least signal the at least one synchronization signal block-specific physical random access channel target receive power value associated with a set of slots or symbols to a user equipment.

In accordance with various example embodiments, an apparatus may include circuitry configured to calculate at least one synchronization signal block-specific physical random access channel target receive power value. The circuitry may further be configured to signal the at least one synchronization signal block-specific physical random access channel target receive power value associated with a set of slots or symbols to a user equipment.

In accordance with some example embodiments, a method may include receiving, by a user equipment, a set of synchronization signal block-specific physical random access channel target receive power values associated with a set of slots or symbols. The method may further include determining, by the user equipment, whether the set of slots or symbols comprises a random access channel occasion.

In accordance with certain example embodiments, an apparatus may include means for receiving a set of synchronization signal block-specific physical random access channel target receive power values associated with a set of slots or symbols. The apparatus may further include means for determining whether the set of slots or symbols comprises a random access channel occasion.

In accordance with various example embodiments, a non-transitory computer readable medium may be encoded with instructions that may, when executed in hardware, perform a method. The method may include receiving a set of synchronization signal block-specific physical random access channel target receive power values associated with a set of slots or symbols. The method may further include determining whether the set of slots or symbols comprises a random access channel occasion.

In accordance with some example embodiments, a computer program product may perform a method. The method may include receiving a set of synchronization signal block-specific physical random access channel target receive power values associated with a set of slots or symbols. The method may further include determining whether the set of slots or symbols comprises a random access channel occasion.

In accordance with certain example embodiments, an apparatus may include at least one processor and at least one memory including computer program code. The at least one memory and the computer program code may be configured to, with the at least one processor, cause the apparatus to at least receive a set of synchronization signal block-specific physical random access channel target receive power values associated with a set of slots or symbols. The at least one memory and the computer program code may be further configured to, with the at least one processor, cause the apparatus to at least determine whether the set of slots or symbols comprises a random access channel occasion.

In accordance with various example embodiments, an apparatus may include circuitry configured to receive a set of synchronization signal block-specific physical random access channel target receive power values associated with a set of slots or symbols. The circuitry may further be configured to determine whether the set of slots or symbols comprises a random access channel occasion.

### BRIEF DESCRIPTION OF THE DRAWINGS

For a proper understanding of example embodiments, reference should be made to the accompanying drawings, wherein:

FIG. 1 illustrates co-channel CLI with dynamic time division duplex (TDD).

FIG. 2 illustrates an example of a Rx beam at a victim base station experiencing higher interference than other Rx beams as it points in the direction of a nearby aggressor base station.

FIGS. 3A-3B illustrate an example of a signalling diagram according to certain example embodiments.

FIG. 4 illustrates an example of a flow diagram of a method according to various example embodiments.

FIG. 5 illustrates an example of a flow diagram of another method according to various example embodiments.

FIG. 6 illustrates an example of various network devices according to some example embodiments.

FIG. 7 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for power controls to allow UE to receive with similar SINR when transmitting during CLI slots and with Rx beam-specific CLI levels at a victim base station is not intended to limit the scope of certain example embodiments, but is instead representative of selected example embodiments.

Third Generation Partnership Project (3GPP) Release (Rel)-15 NR includes support for dynamic TDD, including inter-operator adjacent channel co-existence with dynamic TDD. Performance degradation may be observed in frequency range (FR)1 macro-to-macro scenarios the same TDD configuration is not used across all operators, as well as some scenarios of FR2 macro-to-macro and micro-to-micro. As a result, dynamic TDD may be more suitable for low-power indoor base stations.

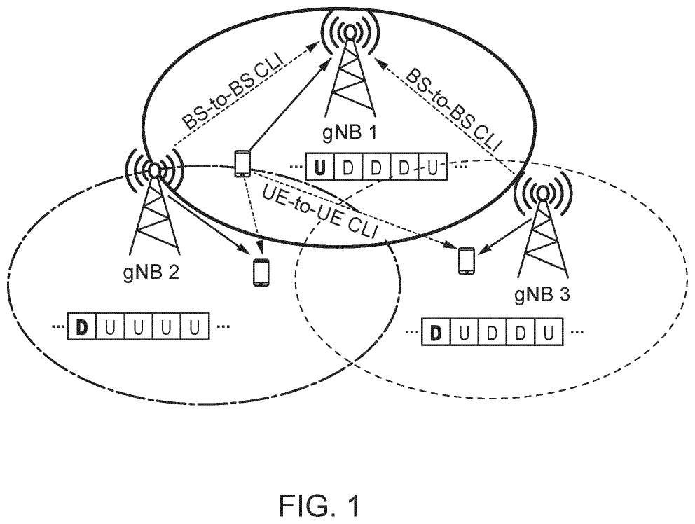

In addition to the challenges with inter-operator co-existence, FIG. 1 illustrates some challenges with intra-operator co-channels created by CLI dynamic TDD. Various techniques have been introduced in 3GPP Rel-16 that are intended to mitigate UE-to-UE intra-operator co-channel CLI (e.g., CLI measurements and reports). Similarly, 3GPP Rel-14 studied techniques in NR intended to mitigate gNB-to-gNB CLI, including advanced gNB receivers capable of rejecting/suppressing gNB-to-gNB CLI; hybrid dynamic/static uplink (UL)/downlink (DL) resource assignment and scheduling coordination techniques (including beam coordination); power control and link adaptation techniques (aiming at enabling different power control and link adaptation configurations depending on the expected interference level in a slot/symbol); and techniques based on sensing to avoid CLI. However, not all of these techniques were introduced and/or can be supported in current NR specifications.

In an effort to enhance dynamic/flexible TDD, solutions may exist to improve management of inter-gNB and inter-UE CLI handling. For example, in NR, a UE may select an SSB (and corresponding PRACH resource) for path-loss estimation and initial access with synchronization signal reference signal received power (SS-RSRP) above a network-configured threshold (rsrp-ThresholdSSB), which may then be signalled by the gNB in system information block (SIB)1.

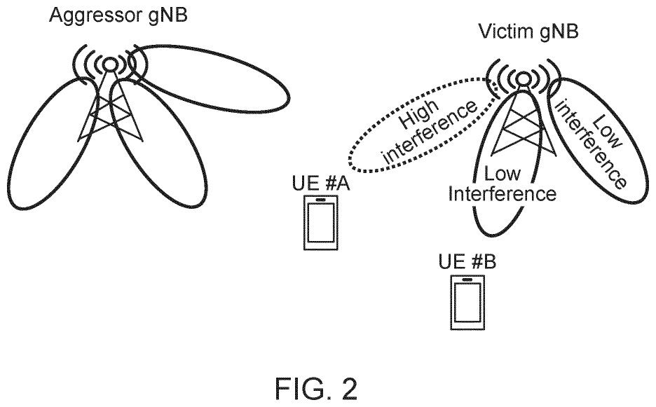

As illustrated in FIG. 2, during beamforming operations at the gNBs, high gNB-to-gNB CLI may be observed at one gNB corresponding with specific slots/symbols (e.g., CLI slots/symbols) and specific Rx beams. CLI slots/symbols may refer to those where an aggressor gNB is transmitting in DL, while a neighbor victim gNB is receiving in UL.

During CLI slots, a gNB receiving in UL may experience greater interference on one or more Rx beams directed at a nearby aggressor gNB (e.g., when the victim gNB tunes its receiver towards a nearby aggressor gNB). For example, two UEs (UE #A and UE #B) with similar pathloss to the victim gNB (i.e., similar transmit power) may be configured with the same target receive power level during CLI slots. The UE whose signal is received at the victim gNB using an Rx beam configuration corresponding with the victim gNB (i.e., UE #A) may observe high interference and experience lower SINR. In comparison, the UE whose signal is received using an Rx beam configuration corresponding with the victim gNB (i.e., UE #B) may experience low interference.

In the example illustrated in FIG. 2 with a grid of beams (GoB), the experienced gNB-to-gNB CLI may depend on the victim gNB Rx beam, as well as which beam the aggressor gNB uses for transmission. Alternatively, this may be affected by the load in the aggressor gNB, and whether single-beam Tx or multi-beam Tx per slot per cell is assumed at the aggressor gNB.

Certain example embodiments described herein may have various benefits and/or advantages to overcome at least the disadvantages described above. Some example embodiments may provide methods for beam-specific power control. For example, certain example embodiments may allow UEs to receive with similar SINR (as compared to slots without CLI) and/or improve the SINR when transmitting during CLI slots and with Rx beam-specific CLI levels at the victim gNB due to, for example, one or more Rx beams of the victim gNB pointing in the direction of a nearby aggressor gNB. By configuring the UE to transmit physical random access channel (PRACH) during slots experiencing Rx beam-specific interference levels (e.g., due to Rx beam-specific CLI caused by one or more Rx beams of the victim gNB pointing in the direction of a nearby aggressor gNB), PRACH may be received with similar SINR independently of the Rx beam, and/or the base station can steer the UE to select SSBs/Rx beam with low CLI. Thus, certain example embodiments discussed below are directed at least to improvements in computer-related technology.

Some example embodiments described herein address the above challenges for UE in Idle/Inactive mode performing random access. In case of UEs in radio resource control (RRC) Connected mode, the gNB may use UE-specific power controls (e.g., power control commands in DCI) to modify the transmission power spectral density depending on the Rx beam used by the gNB when receiving an UL signal from the corresponding UE.

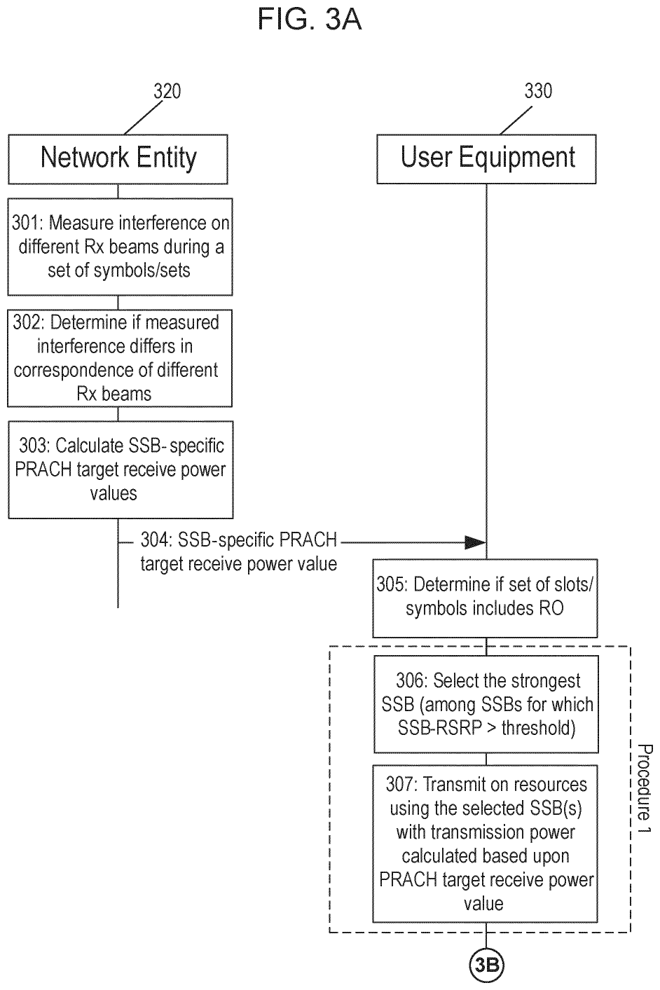

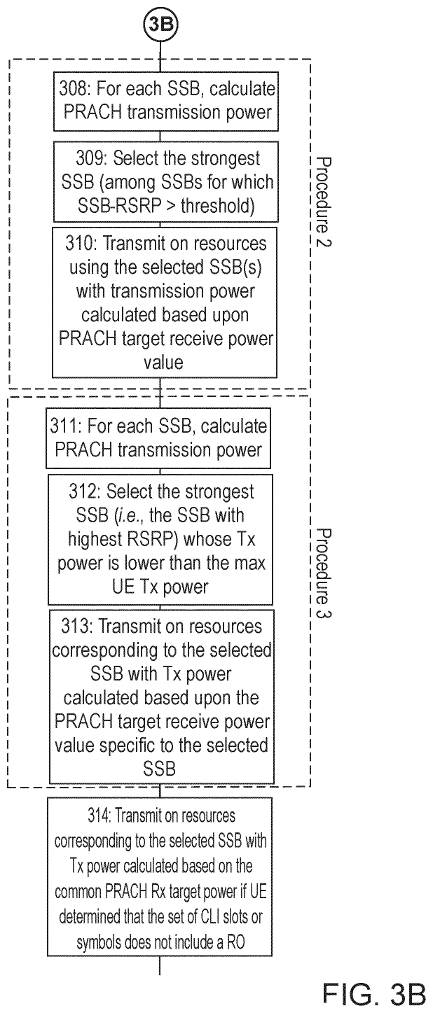

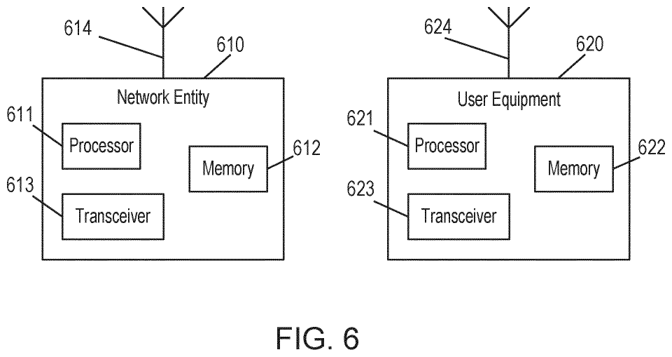

FIG. 3 illustrates an example of a signalling diagram depicting power controls to allow UEs to receive with similar SINR when transmitting during CLI slots and with Rx beam-specific CLI levels at the victim gNB. NE 320 and UE 330 in the example of FIG. 3 may be similar to NE 610 and UE 620, as illustrated in FIG. 6, according to certain example embodiments.

As will be discussed in detail below, certain example embodiments may relate to dynamic TDD scenarios, wherein each gNB (e.g., NE 320) may have a recurring TDD pattern, for example, in the form of DFFFU (or any other TDD pattern (e.g., DFFFFFFFFU)), where ‘D’ refers to a downlink slot, ‘U’ refers to an uplink slot, and ‘F’ refers to a flexible slot which can be used for DL or UL transmissions, as determined independently by each cell (e.g., based on instantaneous traffic demands).

In various example embodiments, ‘F’ slots may be considered CLI slots, while ‘U’ slots may be considered non-CLI slots for corresponding UL transmissions. Alternatively, NE 320 may be aware of the TDD pattern used by neighbor gNBs (e.g., signaled between gNBs using Xₙ interface), and thus, may determine which of the gNB radio slots are potentially subject to CLI. ‘Slots’ (14 OFDM symbols) may be used as the time unit defining the TDD UL/DL switching points; however, any other time units may be used (e.g., in units of subframes or a certain number of orthogonal frequency-division multiplexing (OFDM) symbols).

At 301, NE 320 may measure interference levels received on different Rx beams a set of time slots and/or symbols, for example, CLI slots. As an example, NE 320 may link the interference measurements with a slot type (e.g., CLI slot or no CLI-slot), and/or if the information about the TDD pattern of the aggressor-gNBs is not available at the victim gNB, NE 320 may also use the interference measurements to identify whether the current slot is subject to CLI or not (e.g., if received interference on a certain slot is higher than a certain threshold, then that slot may be regarded as a CLI slot).

Some example embodiments where CSI-RS beams are not available may include GoB operations with a fixed number of Tx/Rx beams per cell and one SSB per beam. Each Rx beam may have a corresponding SSB (DL) beam, which UE 330 may use for pathloss/RSRP measurements and beam management. In various example embodiments, the interference measurements may be collected separately for different slot or symbol types (e.g., CLI and non-CLI slots).

At 302, NE 320 may determine if the measured interference is different in correspondence of different receiver beams. For example, NE 320 may determine the measured SINR corresponding with one specific Rx beam (which may correspond with one specific SSB) as I_CLI_s, where s is the SSB index. NE 320 may use I_CLI_s to ultimately configure UE 330 with SSB-specific PRACH target receive power values. In various example embodiments, the existing preambleReceivedTargetPower parameter inside the 3GPP RACH-ConfigGeneric information element (IE) may be modified to include multiple preambleReceivedTargetPower values per corresponding SSB.

At 303, based upon the measured SINR on one specific Rx beam (which may correspond to one specific SSB), NE 320 may calculate at least one SSB-specific PRACH target receive power value to be used by UE 330 when transmitting PRACH in specific slots/symbols (e.g., CLI slots determined at 301).

In certain example embodiments, NE 320 may configure SSB-specific target receive power values to only apply during specific slots/set of symbols (i.e., where CLI is present), which may occur when UE 330 can distinguish between CLI and non-CLI slots based on gNB signalling (e.g., SIB, RRC, etc.). For example, by leveraging the recurrent nature of the TDD pattern, NE 320 may indicate to UE 330 which specific slots are potential CLI slots by signalling a bitmap (e.g., 01110 (1=CLI slot where the indicated SSB-specific PRACH target receive power value is applied, and 0=non-CLI slot where the default preambleReceivedTargetPower is used)). Each bit may be mapped to one slot of a TDD pattern (e.g., DFFFU). Alternatively, NE 320 may signal that any slot regarded as flexible as per the SIB-/RRC-defined TDD configuration may be regarded as a CLI slot. Additionally or alternatively, NE 320 may signal multiple SSB-specific PRACH target receive power values to UE 330 (e.g., P_{PRACH,target_SSB #n_0}, P_{PRACH,target_SSB #n_1}, . . . P_{PRACH,target_SSB #n_4}), wherein each target receive power value may be mapped one-to-one to the corresponding TDD slot configuration. In general, a higher value of I_CLI_s may correspond to a higher corresponding value of the PRACH target receive power value.

At 304, NE 320 may transmit the at least one SSB-specific PRACH target receive power value configured for the set of slots or symbols, and the SSB-specific PRACH target receive power values calculated at 303 to UE 330, for example, via SIB or RRC signalling. In some example embodiments, when UE 330 transmits in UL corresponding with an SSB during the specifically configured slots/set of symbols, UE 330 may apply the SSB-specific PRACH target receive power values in the corresponding power control formula, for example, P_{PRACHf,c}(i)=min{P_{CMAX,f,c}(i), P_{PRACH,target,f,c}+PL_{b,f,c}} [dBm]. For example, for a PRACH transmission during a slot/set of symbols indicated as CLI by NE 320 at 304, and which is associated to a specific Rx beam/SSB at 303, UE 330 may use the SSB-specific PRACH target receive power value configured for the corresponding SSB in the power control formula to set the PRACH transmission power. The association/correspondence between a PRACH transmission and an SSB may be based on the SSB selection performed during the Random Access procedure. At 305, UE 330 may determine whether the set of slots or symbols includes a random access channel occasion (RO).

In various example embodiments, at 306, UE 330 may select, from among at least one SSB associated with the SSB-specific PRACH target receive power values, the SSB having the highest RSRP. As an example, UE 330 may select at least one SSB which is above a first threshold (e.g., rsrp-ThresholdSSB). At 307, UE 330 may transmit on resources using the selected SSB(s) with transmission power calculated according to the PRACH target receive power value of the selected SSB(s). In some example embodiments, UE 330 may transmit according to P_PRACH=min(P_{CMAX}, P_PRACH_target_SSB+PL_SSB).

In some example embodiments, at 308, UE 330 may calculate, for each of the at least one SSB-specific PRACH target receive power value, PRACH transmission power based upon the set of SSB-specific PRACH target receive power values received at 304. At 309, UE 330 may select, from among the plurality of SSBs with an RSRP above a first threshold value, the SSB corresponding with the lowest PRACH transmission power, based on the received set of SSB-specific PRACH target receive power value. As an example, the max power P_{CMAX} may be configured to be the same or different for CLI and non-CLI slots (e.g., to reduce UE-to-UE CLI in CLI slots/symbols). At 310, UE 330 may transmit on resources corresponding to the selected SSB with transmission power calculated based upon a PRACH target receive power value specific to the selected SSB.

In various example embodiments, at 311, UE 330 may calculate, for each of at least one SSB, PRACH transmission power based upon the received set of SSB-specific PRACH target receive power values. At 312, UE 330 may select, from among the SSBs received with RSRP above a first threshold value, and corresponding with a PRACH transmission power that is lower than the maximum user equipment transmission power by at least a second threshold value. As an example, UE 330 may select the strongest SSB according to P_{CMAX}−(P_{PRACH,target_SSB #n}+PL_{SSB #n})>T, where T is a network configured second threshold value. The SSB may have the highest RSRP. At 313, UE 330 may transmit on resources corresponding to the selected SSB with Tx power calculated based upon the PRACH target receive power value specific to the selected SSB. For example, UE 330 may transmit according to P_PRACH=min(P_{CMAX}, P_PRACH_target+PL_SSB).

At 314, if UE 330 determined at 305 that the set of CLI slots or symbols does not include a RO, UE 330 may transmit on resources corresponding to the selected SSB with Tx power calculated based on the common PRACH Rx target power.

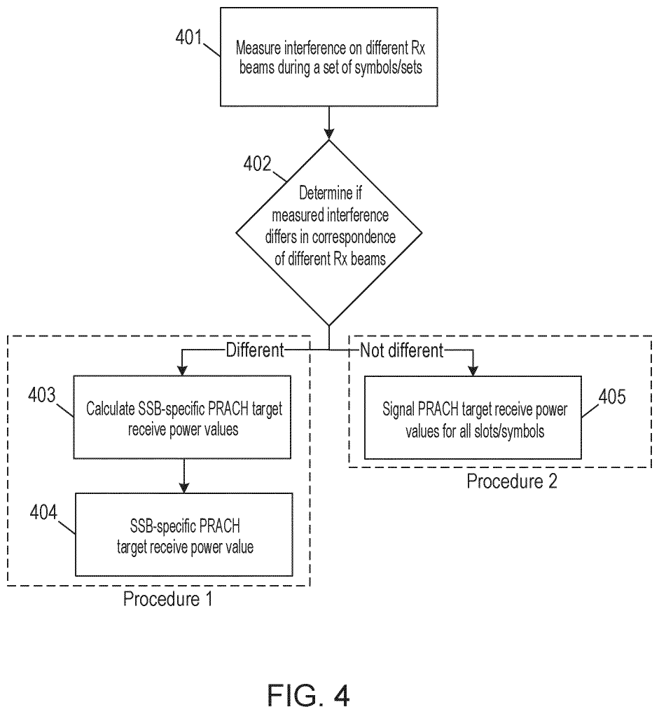

FIG. 4 illustrates an example of a flow diagram of a method that may be performed by a NE, such as NE 610 illustrated in FIG. 6, according to various example embodiments. As will be discussed in detail below, certain example embodiments may relate to dynamic TDD scenarios, wherein each gNB may have a recurring TDD pattern for example, in the form of DFFFU (or any other TDD pattern (e.g., DFFFFFFFFU)), where ‘D’ refers to a downlink slot, ‘U’ refers to an uplink slot, and ‘F’ refers to a flexible slot which can be used for DL or UL transmissions, as determined independently by each cell (e.g., based on instantaneous traffic demands).

In various example embodiments, ‘F’ slots may be considered CLI slots, while ‘U’ slots may be considered non-CLI slots for corresponding UL transmissions. Alternatively, the NE may be aware of the TDD pattern used by neighbor gNBs (e.g., signaled between gNBs using Xₙ interface), and thus, may determine which of the gNB radio slots are potentially subject to CLI. ‘Slots’ (14 OFDM symbols) may be used as the time unit defining the TDD UL/DL switching points; however, any other time units may be used (e.g., in units of subframes or a certain number of OFDM symbols).

At 401, the method may include measuring, by the NE, interference levels received on different Rx beams a set of time slots and/or symbols, for example, CLI slots. As an example, the NE may link the interference measurements with a slot type (e.g., CLI slot or no CLI-slot), and/or if the information about the TDD pattern of the aggressor-gNBs is not available at the victim gNB, NE 320 may also use the interference measurements to identify whether the current slot is subject to CLI or not (e.g., if received interference on a certain slot is higher than a certain threshold, then that slot may be regarded as a CLI slot).

Some example embodiments where CSI-RS beams are not available may include GoB operations with a fixed number of Tx/Rx beams per cell and one SSB per beam. Each Rx beam may have a corresponding SSB (DL) beam, which the UE (which may be similar to UE 620 in FIG. 6) may use for pathloss/RSRP measurements and beam management.

In various example embodiments, the interference measurements may be collected separately for different slot types (e.g., CLI and non-CLI slots). Alternatively, if the information about the TDD pattern of the aggressor-gNBs is not available at the victim gNB, the NE may also use the interference measurements to identify whether the current slot is subject to CLI or not (e.g., if received interference on a certain slot is higher than a certain threshold, then that slot can be regarded as a CLI slot).

At 402, the method may further include determining, by the NE, if the measured interference is different in correspondence of different receiver beams. For example, the NE may determine the measured SINR corresponding with one specific Rx beam (which corresponds to one specific SSB) as I_CLI_s, where s is the SSB index. The NE may use I_CLI_s to configure the UE with SSB-specific PRACH target receive power values. In various example embodiments, the existing preambleReceivedTargetPower parameter inside the 3GPP RACH-ConfigGeneric IE may be modified to include multiple preambleReceivedTargetPower values per corresponding SSB.

At 403, based upon the measured SINR on one specific Rx beam (which may correspond to one specific SSB), if the NE determines that interference is different in correspondence of different Rx beams, the method may include calculating, by the NE, an SSB-specific PRACH target receive power value to be used by the UE when transmitting PRACH in specific slots/symbols (e.g., CLI slots determined at 401). Furthermore, the method may further include linking, by the NE, the interference measurements with a slot or symbol type, and identifying, by the NE, whether the current slot is subject to CLI based upon the interference measurements.

In certain example embodiments, the NE may configure SSB-specific target receive power values to only apply during specific slots/set of symbols (i.e., where CLI is present), which may occur when the UE can distinguish between CLI and non-CLI slots based on gNB signalling (e.g., SIB, RRC, etc.). For example, by leveraging the recurrent nature of the TDD pattern, the NE may indicate to the UE which of the slots are potential CLI slots by signalling a bitmap (e.g., 01110 (1=CLI slot where the indicated SSB-specific PRACH target receive power value is applied, and 0=non-CLI slot where the default preambleReceivedTargetPower is used)). Each bit may be mapped to one slot of a TDD pattern (e.g., DFFFU). Alternatively, the NE may signal that any slot regarded as flexible as per the SIB-/RRC-defined TDD configuration is a CLI slot. Additionally or alternatively, the NE may signal multiple SSB-specific PRACH target receive power values to the UE (e.g., P_{PRACH,target_SSB #n_0}, P_{PRACH,target_SSB #n_1}, . . . P_{PRACH,target_SSB #n_4}), wherein each power value may be mapped one-to-one to the corresponding TDD slot configuration. In general, a higher value of I_CLI_s may indicate a higher corresponding PRACH target receive power value.

Following 403, at 404, the method may including transmitting, by the NE, at least one SSB-specific PRACH target receive power value configured for the set of slots or symbols, and the SSB-specific PRACH target receive power values calculated at 403 to the UE, for example, via SIB or RRC signalling. In some example embodiments, when the UE transmits in UL corresponding with an SSB during the specifically configured slots/set of symbols, the UE may apply the SSB-specific PRACH target receive power value in the corresponding power control formula, for example, P_{PRACHf,c}(i)=min{P_{CMAX,f,c}(i), P_{PRACH,target,f,c}+PL_{b,f,c}} [dBm]. For example, for a PRACH transmission during a slot/set of symbols indicated as CLI by the NE at 404, and which is associated to a specific Rx beam/SSB at 403, the UE may use the SSB-specific PRACH target receive power value configured for the corresponding SSB in the power control formula used to set the PRACH transmission power. The association/correspondence between a PRACH transmission and an SSB may be based on the SSB selection performed during the Random Access procedure.

At 405, if the NE determines at 402 that interference is not different in correspondence of different Rx beams, the method may include signalling, by the NE, PRACH target receive power values for all slots/symbols to the UE.

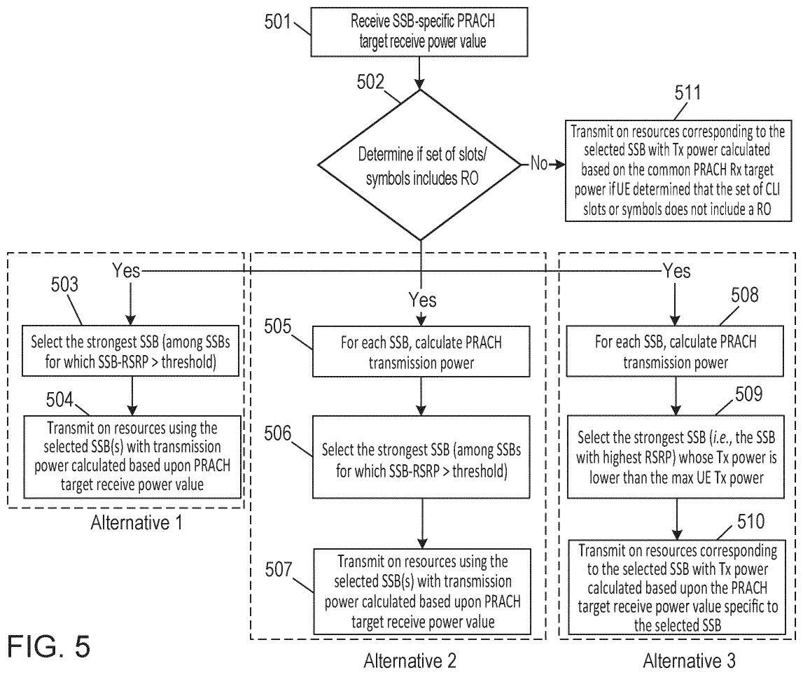

FIG. 5 illustrates an example of a flow diagram of a method that may be performed by a UE, such as UE 620 illustrated in FIG. 6, according to various example embodiments.

At 501, the method may include receiving, by the UE, at least one SSB-specific PRACH target receive power value configured for the set of slots or symbols, and the SSB-specific PRACH target receive power values calculated by a NE (e.g., NE 610 in FIG. 6), for example, via SIB or RRC signalling. In some example embodiments, when the UE transmits in UL corresponding with an SSB during the specifically configured slots/set of symbols, the UE may apply the SSB-specific PRACH target receive power value in the corresponding power control formula. For example, for a PRACH transmission during a slot/set of symbols indicated as CLI by the NE at 501, and which is associated to a specific Rx beam/SSB, the UE may use the PRACH target receive power value configured for the corresponding SSB in the power control formula used to set the PRACH transmission power. The association/correspondence between a PRACH transmission and an SSB may be based on the SSB selection performed during the Random Access procedure. At 502, the method may further include determining, by the UE, whether the set of CLI slots or symbols includes a RO.

In various example embodiments, the UE may use the SSB-specific PRACH target receive power value (P_{PRACH,target_SSB #n}) to select the SSB on which to perform an initial random access procedure (i.e., the UE transmits on PRACH resources corresponding to the selected SSB). For example, in various example embodiments, at 503, if the UE determined at 502 that the set of CLI slots or symbols includes a RO, the UE may select, from among at least one SSB associated with the SSB-specific PRACH target receive power values, the SSB having the highest RSRP based on the received set of SSB-specific PRACH target receive power values. As an example, the UE may select from among SSBs which are above a first threshold (e.g., rsrp-ThresholdSSB). At 504, the method may include transmitting, by the UE, on resources using the selected SSB(s) with transmission power calculated according to the PRACH target receive power value of the selected SSB(s). In some example embodiments, the UE may transmit according to P_PRACH=min(P_{CMAX}, P_PRACH_target_SSB+PL_SSB).

Alternatively, in certain example embodiments, at 505, if the UE determined at 502 that the set of CLI slots or symbols includes a RO, the method may include calculating, by the UE, for each of the at least one SSB-specific PRACH target receive power value, PRACH transmission power based upon the set of SSB-specific PRACH target receive power values received. At 506, the method may further include selecting, by the UE, from among the plurality of SSBs with an RSRP above a first threshold value, the SSB corresponding with the lowest PRACH transmission power, based on the received set of SSB-specific PRACH target receive power value. As an example, the max power P_{CMAX} may be configured to be the same or different for CLI and non-CLI slots (e.g., to reduce UE-to-UE CLI in CLI slots/symbols). At 507, the UE may transmit on resources using the selected SSB according to the PRACH target receive power value of the selected SSB.

In some example embodiments, at 508, the method may include calculating, by the UE, for each of at least one SSB, PRACH transmission power based upon the received set of SSB-specific PRACH target receive power values. At 509, the method may further include selecting, by the UE, from among the SSBs received with RSRP above a first threshold value, the SSB corresponding with transmission power based on the signaled SSB-specific PRACH target receive power values that is lower than the maximum UE transmission power by at least a second threshold value. As an example, the UE may select the strongest SSB according to P_{CMAX}−(P_{PRACH,target_SSB #n}+PL_{SSB #n})>T, where T is a network configured second threshold value. At 510, the method may further include transmitting, by the user equipment, on resources corresponding to the selected SSB with Tx power calculated based upon the PRACH Rx target receive power specific to the selected SSB. For example, the UE may transmit according to P_PRACH=min(P_{CMAX}, P_PRACH_target+PL_SSB).

At 511, if the UE determined at 502 that the set of CLI slots or symbols does not include a RO, the method may include transmitting, by the user equipment, on resources corresponding to the selected SSB with Tx power calculated based on the common PRACH Rx target power.

FIG. 6 illustrates an example of a system according to certain example embodiments. In one example embodiment, a system may include multiple devices, such as, for example, NE 610 and/or UE 620.

NE 610 may be one or more of a base station, such as an eNB or gNB, a serving gateway, a server, and/or any other access node or combination thereof.

NE 610 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 620 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 610 and/or UE 620 may be one or more of a citizens broadband radio service device (CBSD).

NE 610 and/or UE 620 may include at least one processor, respectively indicated as 611 and 621. Processors 611 and 621 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 612 and 622. The memory may be fixed or removable. The memory may include computer program instructions or computer code contained therein. Memories 612 and 622 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 611 and 621, memories 612 and 622, and any subset thereof, may be configured to provide means corresponding to the various blocks of FIGS. 3-5. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 6, transceivers 613 and 623 may be provided, and one or more devices may also include at least one antenna, respectively illustrated as 614 and 624. The device may have many antennas, such as an array of antennas configured for multiple input multiple output (MIMO) communications, or multiple antennas for multiple RATs. Other configurations of these devices, for example, may be provided. Transceivers 613 and 623 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 3-5). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-5. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

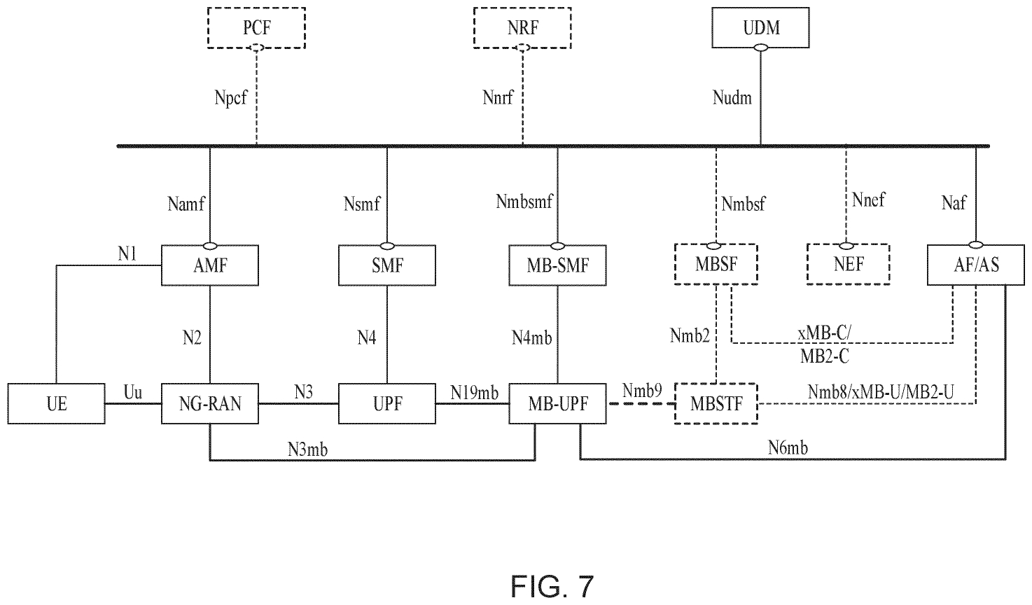

FIG. 7 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 7 may be similar to NE 610 and UE 620, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 611 and 621, and memories 612 and 622, may be included in or may form a part of processing circuitry or control circuitry. In addition, in some example embodiments, transceivers 613 and 623 may be included in or may form a part of transceiving circuitry.

In some example embodiments, an apparatus (e.g., NE 610 and/or UE 620) may include means for performing a method, a process, or any of the variants discussed herein. Examples of the means may include one or more processors, memory, controllers, transmitters, receivers, and/or computer program code for causing the performance of the operations.

In various example embodiments, apparatus 610 may be controlled by memory 612 and processor 611 to calculate at least one synchronization signal block-specific physical random access channel target receive power value, and signal the at least one synchronization signal block-specific physical random access channel target receive power value associated with a set of slots or symbols to a user equipment.

Certain example embodiments may be directed to an apparatus that includes means for performing any of the methods described herein including, for example, means for calculating at least one synchronization signal block-specific physical random access channel target receive power value, and means for signalling the at least one synchronization signal block-specific physical random access channel target receive power value associated with a set of cross link interference slots or symbols to a user equipment.

In various example embodiments, apparatus 620 may be controlled by memory 622 and processor 621 to receive a set of synchronization signal block-specific physical random access channel target receive power values associated with a set of slots or symbols, and determine whether the set of slots or symbols comprises a random access channel occasion.

Certain example embodiments may be directed to an apparatus that includes means for performing any of the methods described herein including, for example, means for receiving a set of synchronization signal block-specific physical random access channel target receive power values associated with a set of slots or symbols, and means for determining whether the set of slots or symbols comprises a random access channel occasion.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP Third Generation Partnership Project
5G Fifth Generation
5GC Fifth Generation Core
5GS Fifth Generation System
6G Sixth Generation
ASIC Application Specific Integrated Circuit
BS Base Station
CBSD Citizens Broadband Radio Service Device
CE Control Elements
CG Configured Grant
CG-SDT Configured Grant Small Data Transmission
CLI Cross Link Interference
CN Core Network
CPU Central Processing Unit
DCI Downlink Control Information
DL Downlink
eMBB Enhanced Mobile Broadband
eMTC Enhanced Machine Type Communication
eNB Evolved Node B
eOLLA Enhanced Outer Loop Link Adaptation
EPS Evolved Packet System
FR Frequency Range
gNB Next Generation Node B
GoB Grid of Beams
GPS Global Positioning System
HDD Hard Disk Drive
IE Information Element
LTE Long-Term Evolution
LTE-A Long-Term Evolution Advanced
MAC Medium Access Control
MEMS Micro Electrical Mechanical System
MIMO Multiple Input Multiple Output
mMTC Massive Machine Type Communication
MTC Machine Type Communication
NAS Non-Access Stratum
NB-IoT Narrowband Internet of Things
NE Network Entity
NG Next Generation
NG-eNB Next Generation Evolved Node B
NG-RAN Next Generation Radio Access Network
NR New Radio
NR-U New Radio Unlicensed
OFDM Orthogonal Frequency Division Multiplexing
OLLA Outer Loop Link Adaptation
PDA Personal Digital Assistance
PRACH Physical Random Access Channel
PUSCH Physical Uplink Shared Channel
QoS Quality of Service
RACH Radio Access Channel
RAM Random Access Memory
RAN Radio Access Network
RAR Random Access Response
RAT Radio Access Technology
RE Resource Element
RF Radio Frequency
RLC Radio Link Control
RO Radio Access Channel Occasion
RRC Radio Resource Control
RSRP Reference Signal Received Power
SDT Small Data Transmission
SIB System Information Block
SINR Signal to Interference Plus Noise Ratio
SMF Session Management Function
SSB Synchronization Signal Block
TDD Time Division Duplex
SS-RSRP Synchronization Signal Reference Signal Received Power
Tx Transmission
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network
xDD Cross-Division Duplexing Scheme

1-45. (canceled)

46. A method, comprising:
receiving, by a user equipment, a set of synchronization signal block-specific physical random access channel target receive power values associated with a set of slots or symbols; and
determining, by the user equipment, whether the set of slots or symbols comprises a random access channel occasion.

47. The method of claim 46, further comprising:
determining, by the user equipment, at least one selected synchronization signal block and a physical random access channel transmission power to be used in correspondence of the set of slots or symbols based on the set of synchronization signal block-specific physical random access channel target receive power values; and wherein the set of slots or symbols comprise cross link interference slots.

48. The method of claim 46, further comprising:
selecting, by the user equipment, a synchronization signal block having a highest reference signal received power; and
transmitting, by the user equipment, on resources corresponding to the selected synchronization signal block with transmission power calculated based upon a physical random access channel target receive power value specific to the selected synchronization signal block.

49. The method of claim 46, further comprising:
calculating, by the user equipment, for each of a plurality of synchronization signal blocks, a physical random access channel transmission power based upon the received set of synchronization signal block-specific physical random access channel target receive power values;
selecting, by the user equipment, from among the plurality of synchronization signal blocks with reference signal received power above a first threshold value, a synchronization signal block corresponding with a lowest physical random access channel transmission power, based on the received set of synchronization signal block-specific physical random access channel target receive power values; and
transmitting, by the user equipment, on resources corresponding to the selected synchronization signal block with transmission power calculated based upon the physical random access channel target receive power value specific to the selected synchronization signal block.

50. The method of claim 46, further comprising:
calculating, by the user equipment, for each of a plurality of synchronization signal blocks, a physical random access channel transmission power based upon the received set of synchronization signal block-specific physical random access channel target receive power values;
selecting, by the user equipment, from among the plurality of synchronization signal blocks received with reference signal received power above a first threshold value, and corresponding with a physical random access channel transmission power that is lower than a maximum user equipment transmission power by at least a second threshold value, a synchronization signal block having a highest reference signal received power; and
transmitting, by the user equipment, on resources corresponding to the selected synchronization signal block with transmission power calculated based upon the physical random access channel target receive power value specific to the selected synchronization signal block.

51. The method of claim 46, wherein an association between a physical random access channel transmission and a synchronization signal block is based at least on selected synchronization signal block performed during a random access procedure.

52. The method of claim 46, wherein the set of synchronization signal block-specific physical random access channel target receive power values are configured to only apply during a specific set of slots or symbols.

53. An apparatus, comprising:
at least one processor; and
at least one memory including computer program code,
wherein the at least one memory and the computer program code are configured to, with the at least one processor, cause the apparatus at least to:
calculate at least one synchronization signal block-specific physical random access channel target receive power value; and
signal the at least one synchronization signal block-specific physical random access channel target receive power value associated with a set of slots or symbols to a user equipment.

54. The apparatus of claim 53, wherein the set of slots or symbols comprise cross link interference slots.

55. The apparatus of claim 53, wherein the at least one memory and the computer program code are further configured to, with the at least one processor, cause the apparatus at least to:
measure interference on different receiver beams during at least the set of slots or symbols; wherein
the interference measurements are collected separately for different slot or symbol types; and
determine if the measured interference is different in correspondence of different receiver beams.

56. The apparatus of claim 55, wherein the at least one memory and the computer program code are further configured to, with the at least one processor, cause the apparatus at least to:
link the interference measurements with a slot or symbol type; and
identify whether a current slot or symbol is subject to cross link interference based upon the interference measurements.

57. The apparatus of claim 53, wherein the at least one synchronization signal block-specific physical random access channel target receive power value is configured to only apply during a specific set of slots or symbols.

58. An apparatus, comprising:
at least one processor; and
at least one memory including computer program code,
wherein the at least one memory and the computer program code are configured to, with the at least one processor, cause the apparatus at least to:
receive a set of synchronization signal block-specific physical random access channel target receive power values associated with a set of slots or symbols; and
determine whether the set of slots or symbols comprises a random access channel occasion.

59. The apparatus of claim 58, wherein the set of slots or symbols comprise cross link interference slots.

60. The apparatus of claim 58, wherein the at least one memory and the computer program code are further configured to, with the at least one processor, cause the apparatus at least to:
determine at least one selected synchronization signal block and a physical random access channel transmission power to be used in correspondence of the set of slots or symbols based on the set of synchronization signal block-specific physical random access channel target receive power values.

61. The apparatus of claim 58, wherein the at least one memory and the computer program code are further configured to, with the at least one processor, cause the apparatus at least to:
select a synchronization signal block having a highest reference signal received power; and
transmit on resources corresponding to the selected synchronization signal block with transmission power calculated based upon a physical random access channel target receive power value specific to the selected synchronization signal block.

62. The apparatus of claim 58, wherein the at least one memory and the computer program code are further configured to, with the at least one processor, cause the apparatus at least to:
calculate for each of a plurality of synchronization signal blocks, a physical random access channel transmission power based upon the received set of synchronization signal block-specific physical random access channel target receive power values;
select from among a plurality of synchronization signal blocks with reference signal received power above a first threshold value, a synchronization signal block corresponding with a lowest physical random access channel transmission power, based on the received set of synchronization signal block-specific physical random access channel target receive power values; and
transmit on resources corresponding to the selected synchronization signal block with transmission power calculated based upon the physical random access channel target receive power value specific to the selected synchronization signal block.

63. The apparatus of claim 58, wherein the at least one memory and the computer program code are further configured to, with the at least one processor, cause the apparatus at least to:
calculate for each of a plurality of synchronization signal blocks, a physical random access channel transmission power based upon the received set of synchronization signal block-specific physical random access channel target receive power values;
select from among a plurality of synchronization signal blocks received with reference signal received power above a first threshold value, and corresponding with a physical random access channel transmission power that is lower than a maximum user equipment transmission power by at least a second threshold value, a synchronization signal block having a highest reference signal received power; and
transmit on resources corresponding to the selected synchronization signal block with transmission power calculated based upon the physical random access channel target receive power value specific to the selected synchronization signal block.

64. The apparatus of claim 58, wherein the interference measurements are collected separately for different slot or symbol types.

65. The apparatus of claim 58, wherein the set of synchronization signal block-specific physical random access channel target receive power values are configured to only apply during a specific set of slots or symbols.
